(19) United States
(12) Patent Application Publication
(10) Pub. No.: US 2018/0259002 A1
(43) Pub. Date: Sep. 13, 2018

(54) TRIPOD TYPE CONSTANT VELOCITY UNIVERSAL JOINT

(71) Applicant: NTN CORPORATION, Osaka (JP)

(72) Inventor: Tatsuro SUGIYAMA, Shizuoka (JP)

(21) Appl. No.: 15/761,226

(22) PCT Filed: Aug. 25, 2016
(86) PCT No.: PCT/JP2016/074861

§ 371 Date: Mar. 19, 2018

(30) Foreign Application Priority Data
Sep. 24, 2015 (JP) 2015-187294

(51) Int. Cl. F16D 3/205

(52) U.S. Cl. CPC F16D 3/2055; F16D 2250/0053

(57) ABSTRACT

A tripod type constant velocity universal joint has an inner circumferential surface of each inner ring which is configured to rotatably support a roller formed to have an arc-shaped protruding section, and an outer circumferential surface of each leg shaft of a tripod member formed to have a straight shape in longitudinal section and a substantially elliptical shape in transverse section. The outer circumferential surface of the leg shaft and the inner circumferential surface of the inner ring are held in contact with each other in a direction orthogonal to an axis of the joint and have a gap between the outer circumferential surface and the inner circumferential surface in an axis direction of the joint. The leg shaft has a hollow hole in which a quench-hardened layer is formed on the outer circumferential surface of the leg shaft and a surface of the hollow hole.

### TECHNICAL FIELD

The present invention relates to a plunging tripod type constant velocity universal joint to be used for power transmission in automobiles, industrial machines, and the like.

### BACKGROUND ART

In a constant velocity universal joint, which is used to construct a power transmission system for automobiles and various industrial machines, two shafts on a driving side and a driven side are coupled to each other to allow torque transmission therebetween, and rotational torque can be transmitted at a constant velocity even when the two shafts form an operating angle. The constant velocity universal joint is roughly classified into a fixed type constant velocity universal joint that allows only angular displacement, and a plunging type constant velocity universal joint that allows both the angular displacement and axial displacement. In a drive shaft configured to transmit power from an engine of an automobile to a driving wheel, for example, the plunging type constant velocity universal joint is used on a differential side (inboard side), and the fixed type constant velocity universal joint is used on a driving wheel side (outboard side).

As one type of a plunging constant velocity universal joint, there has been known a tripod type constant velocity universal joint. As types of the tripod type constant velocity universal joint in terms of a roller being a torque transmission member, there have been known a single-roller type and a double-roller type. In FIG. 11 to FIG. 15, there is illustrated an example of the tripod type constant velocity universal joint of the double-roller type (for example, see Patent Document 1).

FIG. 11 is a partial longitudinal sectional view for illustrating the tripod type constant velocity universal joint. FIG. 12 is a partial transverse sectional view as seen in the direction indicated by the arrows of the line K-K in FIG. 11. As illustrated in FIG. 11 and FIG. 12, the tripod type constant velocity universal joint 101 mainly includes an outer joint member 102, a tripod member 103 serving as an inner joint member, and roller units 104 serving as torque transmission members. The outer joint member 102 has a cup shape having one end being opened. In an inner circumferential surface of the outer joint member 102, there are formed three linear track grooves 105 which are formed at equal intervals in a circumferential direction to extend in an axial direction. On both sides of each track groove 105, there are formed roller guide surfaces 106 which are arranged opposed to each other in the circumferential direction to extend in the axial direction. The tripod member 103 and the roller units 104 are received in the outer joint member 102. The tripod member 103 includes three leg shafts 107 protruding in a radial direction. A male spline 124 formed on a shaft 109 is fitted to a female spline 123 formed in a center hole 108 of the tripod member 103, and the tripod member 103 and the shaft 109 are fixed by a stop ring 110 in the axial direction. The roller units 104 each mainly include an outer ring 111 being a roller, an inner ring 112 which is arranged on an inner side of the outer ring 111 and externally fitted to the leg shaft 107, and a large number of needle rollers 113 interposed between the outer ring 111 and the inner ring 112. The roller units 104 are received in the track grooves 105 of the outer joint member 102. An inner circumferential surface 112a of the inner ring 112 has an arc-shaped protruding surface in longitudinal section including an axis of the inner ring 112. The roller unit 104 including the inner ring 112, the needle rollers 113, and the outer ring 111 has a structure in which washers 114 and 115 prevent separation of the components.

An outer circumferential surface of each leg shaft 107 of the tripod member 103 is formed so as to have a straight shape in longitudinal section including an axis of the leg shaft 107. Further, as illustrated in FIG. 1.3 which is a plan view as seen in the direction indicated by the arrows of the line L-L in FIG. 11, the outer circumferential surface of each leg shaft 107 is formed so as to have a substantially elliptical shape in transverse section orthogonal to the axis of the leg shaft 107. The outer circumferential surface of each leg shaft 107 is held in contact with the inner circumferential surface 112a of the inner ring 112 in a direction orthogonal to an axis of the joint, that is, in a direction of a long axis “a”, and has a gap “m” with the inner circumferential surface 112a of the inner ring 112 in an axis direction of the joint, that is, in a direction of a short axis “b”.

With reference to FIG. 11 and FIG. 12, in the constant velocity universal joint 101, the outer ring 111 of the roller unit 104 mounted to the leg shaft 107 of the tripod member 103 rolls on the roller guide surfaces 106 of the track groove 105 of the outer joint member 102. The leg shaft 107 has the substantially elliptical shape in transverse section, and the inner circumferential surface 112a of the inner ring 112 is the arc-shaped protruding surface. Therefore, when the constant velocity universal joint 101 forms an operating angle, the axis of the tripod member 103 is inclined with respect to the axis of the outer joint member 102, but the roller unit 104 can be inclined with respect to the axis of the leg shaft 107 of the tripod member 103. Thus, the outer ring 111 of the roller unit 104 and the roller guide surfaces 106 are prevented from obliquely intersecting with each other, and the roller unit 104 correctly rolls, thereby being capable of reducing induced thrust and slide resistance, and achieving reduction in oscillation of the joint.

### PRIOR ART DOCUMENTS

### Patent Documents

Patent Document 1: JP 3699618 B2

### SUMMARY OF THE INVENTION

### Problems to be Solved by the Invention

According to the tripod type constant velocity universal joint 101 disclosed in Patent Document 1, in order to secure the strength and rolling life of the contact portion between the leg shaft 107 and the roller unit 104, a quench-hardened layer is formed on an entire surface of the tripod member 103 through thermal treatment such as carburizing, quenching, and tempering. The quench-hardened layer H has an effective hardened layer depth of from about 1 mm to about 2 mm. However, the contact portion between the leg shaft 107 and the roller unit 104 has high contact pressure. Therefore, in consideration of further improvement in life during application of high load, it is required to increase the effective hardened layer depth.

Herein, the effective hardened layer depth is defined as a depth range having a minimum value obtained by multiplying a value of a maximum shear stress generating depth ZST, which is calculated based on a contact portion load and a contact ellipse of the leg shaft 107 and the roller unit 104 given during application of high torque to the constant velocity universal joint 101, by a safety factor (1.5 times to 3 times). Further, the effective hardened layer depth generally has a range of Hv 513 (HRC 50) or more, and an overall hardened layer depth has a range which is obtained through hardening by heat treatment to a material hardness higher than that given before heat treatment. The material hardness is from about Hv 300 to Hv 390 (from about HRC 30 to about HRC 40).

In FIG. 15, there is shown hardness distribution from the outer circumferential surface of the leg shaft 107 of FIG. 14b to an inner portion. In FIG. 15, De represents the effective hardened layer depth, and Dt represents the overall hardened layer depth.

As illustrated in FIG. 14a, the leg shaft 107 of the tripod member 103 has a solid structure. When the effective hardened layer depth De of the leg shaft 107 is set larger, the quenching effective hardened layer depth De on each of surfaces of a trunnion barrel 103a and the female spline 123 other than the leg shaft 107 is also increased. Therefore, it has been found that, in consideration of strength, the above-mentioned structure has problems such as a fear of degradation in strength and increase in quenching cost due to longer heat treatment time.

Meanwhile, In recent years, there has been increasing a demand for higher fuel efficiency of automobiles, thereby arousing a strong desire for further weight reduction of the constant velocity universal joint as one of the components of automobiles. It has been found that any means being extension of the tripod constant velocity universal joint 101 disclosed in Patent Document 1 is inadequate to meet also the above-mentioned demand.

In view of the above-mentioned problem, the present invention has an object to provide a tripod type constant velocity universal joint of a double-roller type, which achieves improvement in strength and life and reduction in weight.

### Solution to Problem

The present invention has been made as a result of various studies conducted to achieve the above-mentioned object, and the inventor of the present invention has conceived of a new idea of forming a hollow hole in the leg shaft of the tripod member, obtaining a quench-hardened layer continuous from the hollow hole, and combining the quench-hardened layers on the radially outer side and the radially inner side of the leg shaft to increase the quench-hardened layer depth only at the portion of the leg shaft.

As technical means for achieving the above-mentioned object, according to one embodiment of the present invention, there is provided a tripod type constant velocity universal joint, comprising: an outer joint member having three track grooves each having roller guide surfaces arranged opposed to each other in a circumferential direction; a tripod member comprising three leg shafts protruding in a radial direction; rollers inserted to the track grooves; and inner rings, which are externally fitted to the leg shafts, and are configured to rotatably support the rollers, the rollers each being movable along the roller guide surfaces in an axial direction of the outer joint member, the inner rings each having an inner circumferential surface formed so as to have an arc-shaped protruding section, the leg shafts each having an outer circumferential surface formed so as to have a straight shape in longitudinal section and a substantially elliptical shape in transverse section, the outer circumferential surface of each of the leg shafts being held in contact with the inner circumferential surface of each of the inner rings in a direction orthogonal to an axis of the joint, and having a gap with the inner circumferential surface of the each of the inner rings in an axis direction of the joint, wherein the each of the leg shafts has a hollow hole, wherein the outer circumferential surface of the each of the leg shafts and a surface of the hollow hole each have a quench-hardened layer, and wherein the quench-hardened layer is continuous in a radial direction of the each of the leg shafts from the outer circumferential surface of the each of leg shafts to the surface of the hollow hole. With the above-mentioned configuration, a tripod type constant velocity universal joint which attains improvement in strength and life and reduction in weight can be achieved.

When the quench-hardened layer is formed by carburizing, quenching, and tempering, the quench-hardened layer can be formed with high productivity on the outer circumferential surface of the leg shaft of the tripod member and on the surface of the hollow hole.

Now, the quench-hardened layer described in Claims and Description of the present application is defined as follows. As mentioned above, the effective hardened layer depth is defined as a depth range having a minimum value obtained by multiplying a value of a maximum shear stress generating depth ZST, which is calculated based on a contact portion load and a contact ellipse of the leg shaft and the inner ring (roller unit) given during application of high torque to the constant velocity universal joint, by a safety factor (1.5 times to 3 times). The effective hardened layer depth is generally defined as a range of Hv513 (HRC50) or more. Further, the quench-hardened layer described in Claims and Description of the present application is defined as a hardened layer having the effective hardened layer depth defined as described above. The overall hardened layer depth is defined as a range which is obtained through hardening by heat treatment to a material hardness higher than that given before heat treatment. The material hardness is from about Hv 300 to about Hv 390 (from about HRC 30 to about HRC 40).

When the hollow hole has an elliptical cylinder shape having a bottom portion, the quench-hardened layer can be securely formed from the outer circumferential surface of the leg shaft of the tripod member to the surface of the hollow hole, and the quench-hardened layer which is continuous on the entire surface of the hollow hole including the bottom portion can be formed, thereby being capable of effectively achieving the improvement in strength and life and reduction in weight.

When the hollow hole has a circular cylinder shape having a bottom portion, the hollow hole of the leg shaft of the tripod member can be easily formed, and the quench-hardened layer can be formed from the outer circumferential surface of the leg shaft to the surface of the hollow hole. Further, the quench-hardened layer which is continuous on the entire surface of the hollow hole including the bottom portion can be formed, thereby being capable of achieving improvement in strength and life and reduction in weight.

When the hollow hole is formed of a forged surface, additional processing is not required, thereby being capable of reducing the manufacturing cost.

### Effects of the Invention

According to the present invention, the tripod type constant velocity universal joint which attains improvement in strength and life and reduction in weight can be achieved.

### BRIEF DESCRIPTION OF DRAWINGS

FIG. 1 is a longitudinal sectional view for illustrating a tripod type constant velocity universal joint according to one embodiment of the present invention.

FIG. 2 is a partial transverse sectional view as seen in the direction indicated by the arrows of the line K-K in FIG. 1.

FIG. 3 is a plan view as seen in the direction indicated by the arrows of the line L-L in FIG. 1.

FIG. 4 is a longitudinal sectional view for illustrating a state in which the tripod type constant velocity universal joint of FIG. 1 forms an operating angle.

FIG. 5 is a transverse sectional view for illustrating details of the tripod member of FIG. 2.

FIG. 6a is a transverse sectional view for illustrating a hollow hole of a leg shaft of the tripod member of FIG. 5.

FIG. 6b is a sectional view taken along the line X-X in FIG. 6a.

FIG. 7a is a transverse sectional view for illustrating a quench-hardened layer of the tripod member of FIG. 2.

FIG. 7b is a sectional view taken along the line X-X in FIG. 7a.

FIG. 8 is a graph for showing hardness distribution from an outer circumferential surface S1 of the leg shaft of FIG. 7a to a surface S2 of the hollow hole.

FIG. 9a is a sectional view for illustrating a modification example of the hollow hole of the leg shaft of the tripod member.

FIG. 9b is a sectional view for illustrating another modification example of the hollow hole of the leg shaft of the tripod member.

FIG. 10 is a transverse sectional view for illustrating still another modification example of the hollow hole of the leg shaft of the tripod member.

FIG. 11 is a longitudinal sectional view for illustrating a related-art tripod type constant velocity universal joint.

FIG. 12 is a partial transverse sectional view as seen in the direction indicated by the arrows of the line K-K in FIG. 11.

FIG. 13 is a plan view as seen in the direction indicated by the arrows of the line L-L in FIG. 11.

FIG. 14a is a transverse sectional view for illustrating a detailed shape of the tripod member of FIG. 12.

FIG. 14b is a transverse sectional view for illustrating a quench-hardened layer of the tripod member of FIG. 12.

FIG. 15 is a graph for showing hardness distribution from an outer circumferential surface S of the leg shaft of FIG. 14b toward an inner portion.

### EMBODIMENTS OF THE INVENTION

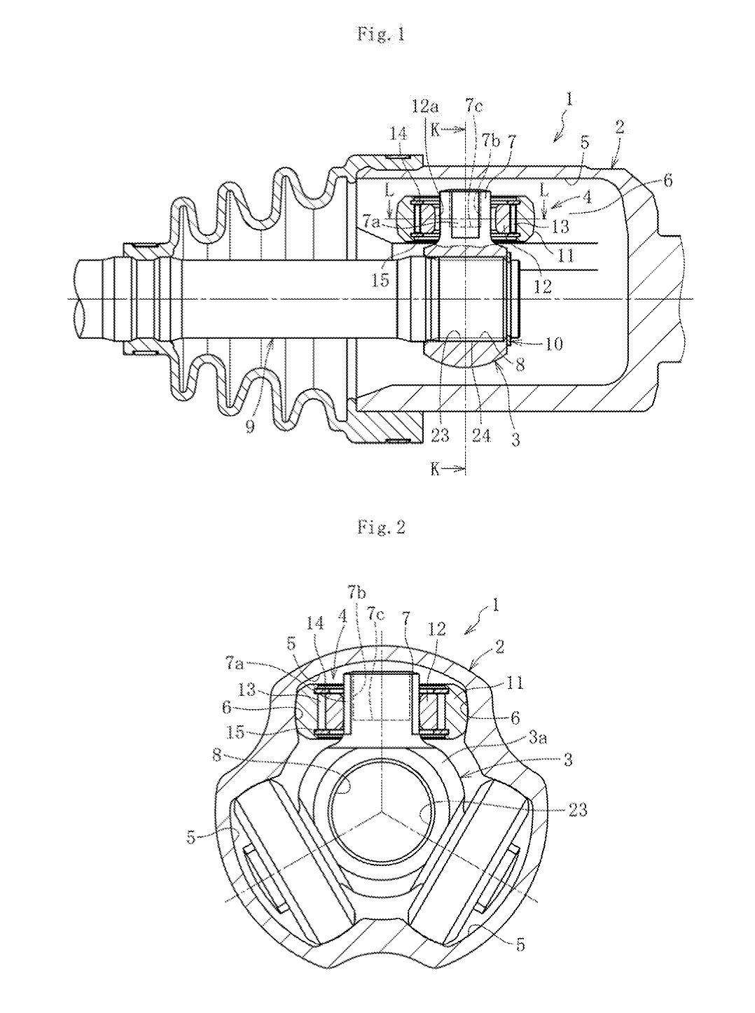

A tripod type constant velocity universal joint according to one embodiment of the present invention is described with reference to FIG. 1 to FIG. 8. FIG. 1 is a longitudinal sectional view for illustrating a tripod type constant velocity universal joint of a double-roller type. FIG. 2 is a partial transverse sectional view as seen in the direction indicated by the arrows of the line K-K in FIG. 1. As illustrated in FIG. 1 and FIG. 2, a tripod type constant velocity universal joint 1 mainly comprises an outer joint member 2, a tripod member 3 serving as an inner joint member, and roller units 4 serving as torque transmission members. The outer joint member 2 has a cup shape having one end being opened. In an inner circumferential surface of the outer joint member 2, there are formed three linear track grooves 5 which are formed at equal intervals in a circumferential direction to extend in an axial direction. On both sides of each track groove 5, there are formed roller guide surfaces 6 which are arranged opposed to each other in the circumferential direction to extend in the axial direction. The tripod member 3 and the roller units 4 are received in the outer joint member 2.

The tripod member 3 comprises three leg shafts 7 protruding in a radial direction from a trunnion barrel 3a. A male spline 24 formed on a shaft 9 is fitted to a female spline 23 formed in a center hole 8 of the tripod member 3, and the tripod member 3 and the shaft 9 are fixed by a stop ring 10 in the axial direction. The roller units 4 each mainly comprise an outer ring 11 being a roller, an inner ring 12 which is arranged on an inner side of the outer ring 11 and externally fitted to a leg shaft 7, and a large number of needle rollers 13 interposed between the outer ring 11 and the inner ring 12. The roller units 4 are received in the track grooves 5 of the outer joint member 2. An inner circumferential surface 12a (see FIG. 1) of the inner ring 12 has an arc-shaped protruding surface in longitudinal section including an axis of the inner ring 12. The roller unit 4 comprising the inner ring 12, the needle rollers 13, and the outer ring 11 has a structure in which washers 14 and 15 prevent separation of the components.

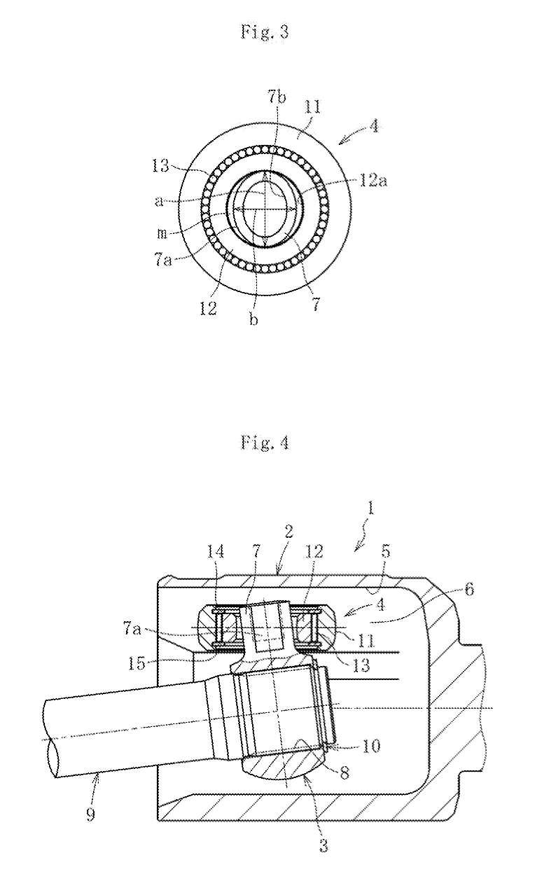

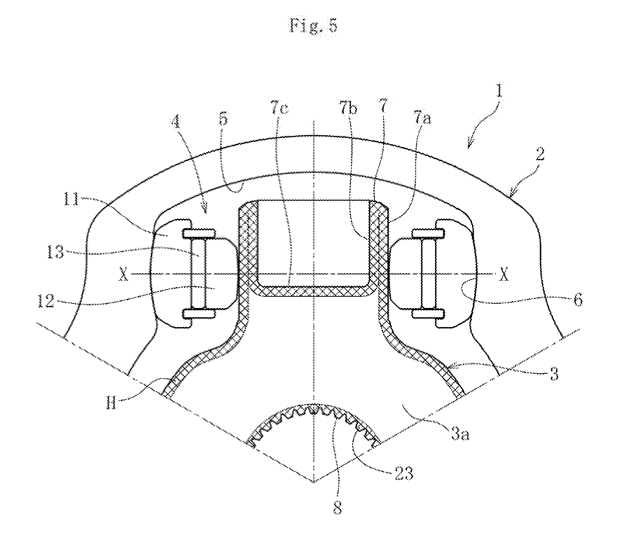

An outer circumferential surface 7a of each leg shaft 7 of the tripod member 3 is formed so as to have a straight shape in longitudinal section including an axis of the leg shaft 7. Further, as illustrated in FIG. 3 which is a plan view as seen in the direction indicated by the arrows of the line L-L in FIG. 1, the outer circumferential surface 7a of each leg shaft 7 is formed so as to have a substantially elliptical shape in transverse section orthogonal to the axis of the leg shaft 7. The outer circumferential surface 7a of each leg shaft 7 is held in contact with the inner circumferential surface 12a of the inner ring 12 in a direction orthogonal to an axis of the joint, that is, in a direction of a long axis “a”, and has a gap “m” with the inner circumferential surface 12a of the inner ring 12 in an axis direction of the joint, that is, in a direction of a short axis “b”. As illustrated in FIG. 1 to FIG. 3, a hollow hole 7b having an elliptical cylinder shape is formed at a center of each leg shaft 7 of the tripod member 3, and the hollow hole 7b has a bottom portion 7c.

In the tripod type constant velocity universal joint 1, the outer ring 11 of the roller unit 4 mounted to the leg shaft 7 of the tripod member 3 rolls on the roller guide surfaces 6 of the track groove 6 of the outer joint member 2 (see FIG. 1 and FIG. 2). The leg shaft 7 has a substantially elliptical shape in transverse section, and the inner circumferential surface 12a of the inner ring 12 is the arc-shaped protruding surface. Therefore, as illustrated in FIG. 4, when the tripod type constant velocity universal joint 1 forms an operating angle, the axis of the tripod member 3 is inclined with respect to the axis of the outer joint member 2, but the roller unit 4 can be inclined with respect to the axis of the leg shaft 7 of the tripod member 3. Thus, the outer ring 11 of the roller unit 4 and the roller guide surfaces 6 are prevented from obliquely intersecting with each other, and the roller unit 4 correctly rolls, thereby being capable of reducing induced thrust and slide resistance, and achieving reduction in oscillation of the joint.

In particular, in the tripod type constant velocity universal joint 1, the outer circumferential surface 7a of the leg shaft 7 has a substantially elliptical shape in transverse section, and the inner circumferential surface 12a of the inner ring 12 has an arc-shaped protruding surface in longitudinal section including an axis of the inner ring 12. Thus, the outer circumferential surface 7a of the leg shaft 7 and the inner circumferential surface 12a of the inner ring 12 are held in contact with each other in a small area, that is, substantially in a point-contact state. Therefore, friction resistance is extremely small in the inclination motion of the roller unit 4 and the leg shaft 7, and the outer circumferential surface 7a of the leg shaft 7 and the inner circumferential surface 12a of the inner ring 12 roll and swing with respect to minor extension and retraction motions. Thus, there can be achieved the effect in that reduction in oscillation of the joint is conspicuous. However, a contact area of the contact portion between the outer circumferential surface 7a of the leg shaft 7 and the inner circumferential surface 12a of the inner ring 12 is small. Therefore, it is required to take a countermeasure with respect to increase in contact pressure at the contact portion during application of high load.

In order to achieve improvement in strength and life and reduction in weight, the tripod type constant velocity universal joint 1 according to this embodiment has the following features. That is, the leg shaft 7 of the tripod member 3 has the hollow hole 7b. The outer circumferential surface 7a of the leg shaft 7 and the surface of the hollow hole 7b each have a quench-hardened layer. The quench-hardened layer is continuous in the radial direction of the leg shaft 7 from the outer circumferential surface 7a of the leg shaft 7 to the surface of the hollow hole 7b. Those features are described with reference to FIG. 5 to FIG. 8.

FIG. 5 is a view for illustrating details of the tripod member 3, and is an illustration of a one-third portion of the transverse section of FIG. 2. The remaining two-third portion which is omitted from illustration is also the same (this similarly applies to subsequent drawings). The hollow hole 7b having an elliptical cylindrical shape is formed at the center of the leg shaft 7 of the tripod member 3, and the hollow hole 7b has the bottom portion 7c. The female spline 23 is formed along an inner peripheral hole 8 of the trunnion barrel 3a. On an entire surface of the tripod member 3, there is formed a quench-hardened layer H by carburizing, quenching, and tempering. The quench-hardened layer H is cross-hatched within the range of the effective hardened layer depth. This similarly applies to the subsequent drawings.

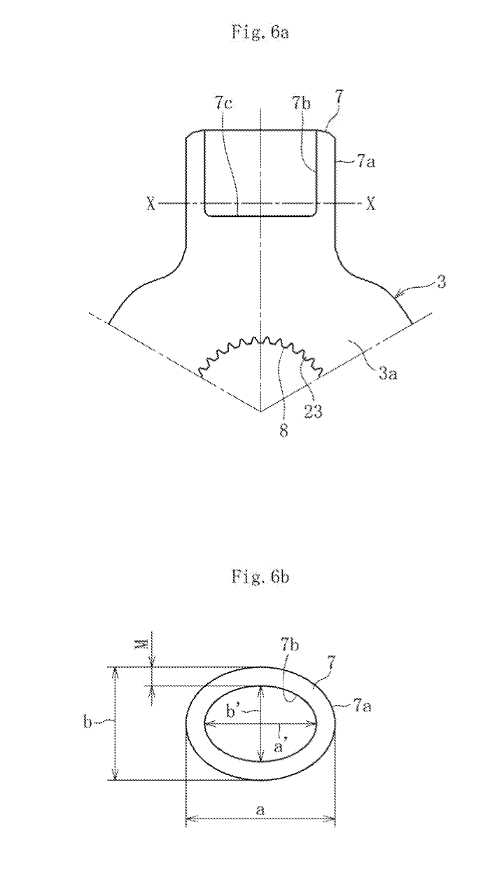

FIG. 6a is an illustration of a transverse section corresponding to a one-third portion of the tripod member 3. The tripod member 3 is made of case hardening steel, such as chromium steel (for example, SCr420) or chromium-molybdenum steel (for example, SCM420). The hollow hole 7b of the leg shaft 7 is formed of a forged surface obtained by forging the tripod member 3. The line X-X in FIG. 6a is a position at which a center of the roller unit 4 in the width direction is held in contact with the outer circumferential surface 7a of the leg shaft 7 under a state in which the operating angle of the joint is 0° (see FIG. 5). When the tripod type constant velocity universal joint 1 forms an operating angle, the roller unit 4 moves in the axial direction of the leg shaft 7. Therefore, in consideration of the movement of the roller unit 4, the bottom portion 7c of the hollow hole 7b is formed at a deeper position with a suitable dimension from the X-X line. The trunnion barrel 3a and the female spline 23 other than the leg shaft 7 are the same as those of the related art.

The shape of the hollow hole 7b is described with reference to FIG. 6b. FIG. 6b is a sectional view taken along the line X-X in FIG. 6a. As mentioned above, the outer circumferential surface 7a of the leg shaft 7 has the substantially elliptical shape having the long axis “a” and the short axis “b”. The hollow hole 7b has an elliptical cylinder shape having a long axis a′ and a short axis b′, and a thickness M is substantially uniform in the circumferential direction. When the hollow hole 7b is formed of a forged surface, additional processing is not required, thereby being capable of suppressing the manufacturing cost. The thickness M is suitably set in consideration of a sum of depths of the quench-hardened layers on the radially outer side (outer circumferential surface 7a side) and the radially inner side (hollow hole 7b side) of the leg shaft 7, and is from about 3 mm to about 4 mm. In this embodiment, description is made of the example in which the hollow hole 7b is formed by forging. However, not limited to this method, the hollow hole 7b may be formed by machining such as cutting.

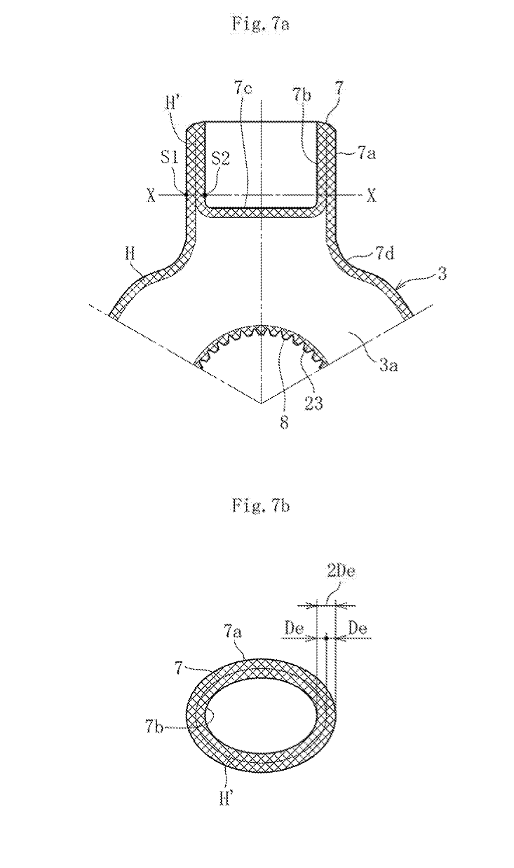

With reference to FIG. 7a and FIG. 7b, description is made of details of the quench-hardened layer H. FIG. 7b is a sectional view taken along the line X-X of FIG. 7a. The quench-hardened layer H is formed on the entire surface of the tripod member 3. The quench-hardened layer H is continuously formed so as to extend from a surface of the trunnion barrel 3a throughout a root portion 7d, the outer circumferential surface 7a having the elliptical cylinder shape, the hollow hole 7b, and the bottom portion 7c of the leg shaft 7. When the quench-hardened layer H which is continuous on the entire surface of the hollow hole 7b including the bottom portion 7c is formed, the strength and stiffness of the leg shaft 7 can be increased. The surface hardness of the quench-hardened layer H is from about HRC 58 to about HRC 61.

The bottom portion 7c of the hollow hole 7b is formed at a deeper position with a suitable dimension from the line X-X in consideration of the movement of the roller unit 4, and hence the quench-hardened layers H on the radially outer side (outer circumferential surface 7a side) and the radially inner side (hollow hole 7b side) of the leg shaft 7 are combined within the movement range of the roller unit 4 on the leg shaft 7. As a result, within the movement range of the roller unit 4, as illustrated in FIG. 7a and FIG. 7b, the effective hardened layer depth De of the quench-hardened layer H on the outer circumferential surface 7a side of the leg shaft 7 and the effective hardened layer depth De of the quench-hardened layer H on the hollow hole 7b side are summed up, thereby being capable of obtaining a quench-hardened layer H′ having an effective hardened layer depth 2De in appearance. That is, even when the effective hardened layer depth De of the quench-hardened layer H is set to a depth required for securing strength of the leg shaft 7 and rolling life of the contact portion between the leg shaft 7 and the roller unit 4, the quench-hardened layer H′ having the effective hardened layer depth 2De is given only to the portion of the leg shaft 7, thereby increasing the quench-hardened layer depth. The effective hardened layer depths De of the quench-hardened layers H on the female spline 23 and the trunnion barrel 3a other than the leg shaft 7 are the same as those of the related art. With this configuration, manufacture can be performed without degradation in strength of portions other than the leg shaft 7 (female spline 23 and trunnion barrel 3a) and increase in quenching cost.

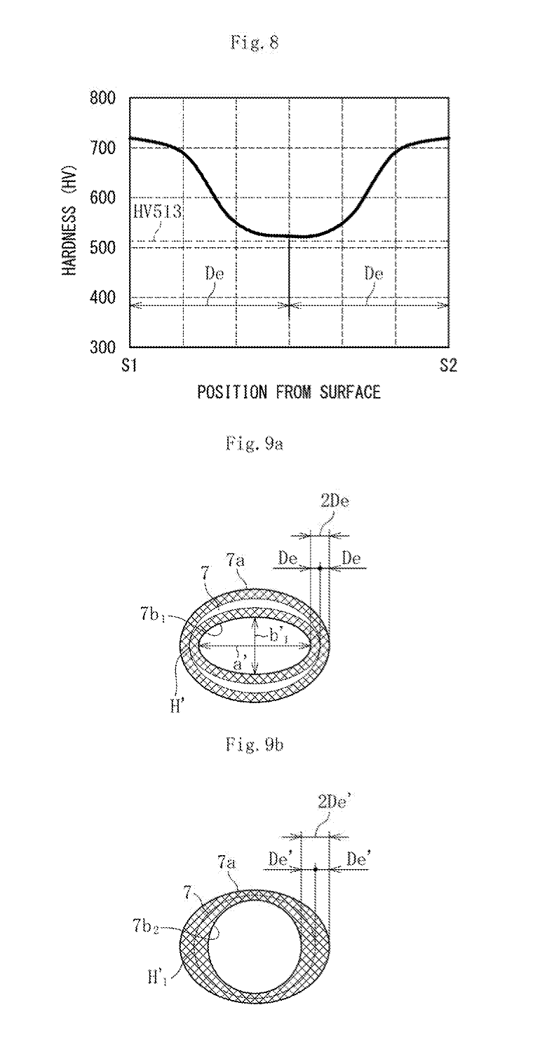

In FIG. 8, there is shown hardness distribution from an outer circumferential surface S1 of the leg shaft 7 of FIG. 7a to a surface S2 of the hollow hole 7b. The quench-hardened layer H having the effective hardened layer depth De is formed on each of the radially outer side (outer circumferential surface 7a side) and the radially inner side (hollow hole 7b side) of the leg shaft 7. In this embodiment, the quench-hardened layers H on the radially outer side and the radially inner side of the leg shaft 7 are combined. Thus, the core hardness is HV 513 (HRC 50) or more, and it is confirmed that the quench-hardened layer H′ having an effective hardened layer depth substantially equal to the effective hardened layer depth 2De can be obtained only at the portion of the leg shaft 7. The surface hardness is HV 720 (HRC 61). Further, the core hardness (HV 513 or more) of the leg shaft 7 is higher than the core hardness (about HV 400) of the portions other than the leg shaft 7, and hence strength and stiffness of the leg shaft 7 increase.

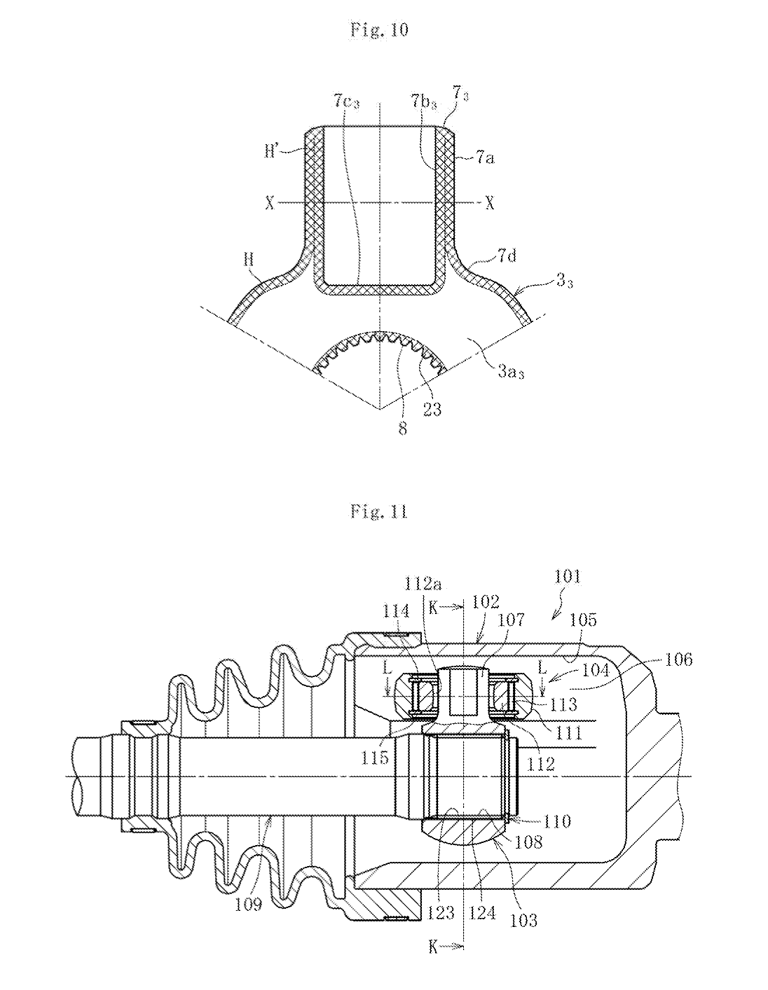

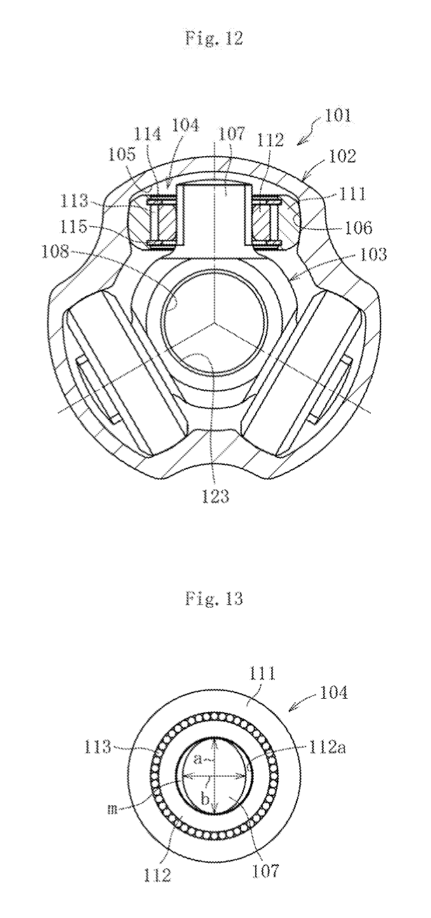

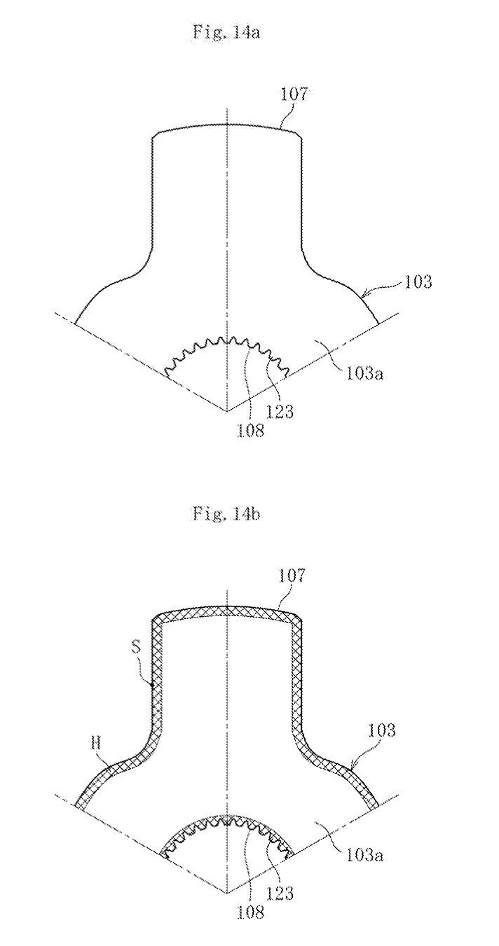

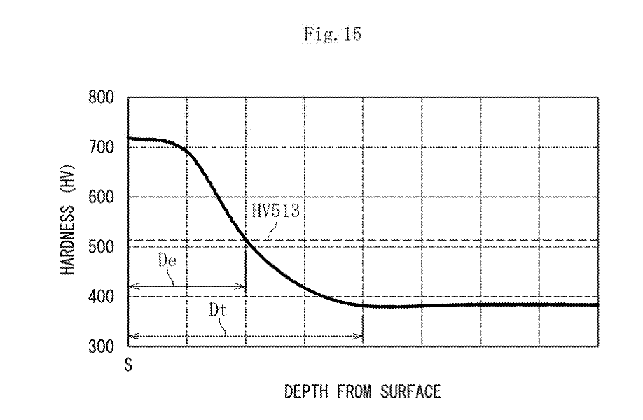

Modification examples of the hollow hole are described with reference to FIG. 9a and FIG. 9b. FIG. 9a and FIG. 9b are sectional views similar to the sectional view of FIG. 7b, and the transverse sectional view of the tripod member is omitted. In the modification example illustrated in FIG. 9a, the elliptical shape of a hollow hole 7b₁ is different from the hollow hole 7b in the above-mentioned embodiment. The elliptical shape of the hollow hole 7b₁ in this modification example has the long axis a′ equal to that of the hollow hole 7b in the embodiment, and has a shorter short axis b′₁, to thereby increase the ellipticity. In the direction orthogonal to the axis of the joint, the quench-hardened layers H on the radially outer side (outer circumferential surface 7a side) and the radially inner side (hollow hole 7b₁ side) of the leg shaft 7 are combined, thereby forming the quench-hardened layer H′ having an effective hardened layer depth substantially equal to the effective hardened layer depth 2De. In the axis direction of the joint, the thickness of the outer circumferential surface 7a and the hollow hole 7b₁ is large. Therefore, non-hardened portions are present, and hence it is advantageous in terms of toughness of the leg shaft 7. Other configurations and actions are the same as those of the tripod type constant velocity universal joint 1 according to the above-mentioned embodiment. Therefore, contents of the description in the embodiment are applied to omit redundant description. This similarly applies to another modification example illustrated in next FIG. 9b.

A hollow hole 7b2 in another modification example illustrated in FIG. 9b has a circular cylinder shape. A transverse section of the hollow hole 7b₂ has a circular shape. Therefore, in the direction orthogonal to the axis of the joint, the thickness of the outer circumferential surface 7a and the hollow hole 7b2 is slightly larger, and hence a quench-hardened layer H′₁ having an effective hardened layer depth 2De′ in conformity with the above-mentioned configuration is formed. The hollow hole 7b in this modification example has the circular cylinder shape. Therefore, processing can be easily performed when the hollow hole 7b2 is formed by machining such as cutting.

In FIG. 10, there is illustrated still another modification example of the hollow hole. FIG. 10 is a transverse sectional view corresponding to FIG. 7a. In this modification example, a hollow hole 7b is set deeper, and a bottom portion 7c3 is located in the vicinity of the root portion 7d of a tripod member 33. With this configuration, the tripod member 3K can be significantly reduced in weight. Although illustration of the shape of the transverse section of the hollow hole 7b3 is omitted, any shape of the transverse section, that is, any one of the elliptical shape of the hollow hole 7b in the above-mentioned embodiment, the shape of the hollow hole 7b₁ (elliptical shape having large ellipticity) in the modification example illustrated in FIG. 9a, and the shape of the hollow hole 7b₂ (circular shape) in the modification example illustrated in FIG. 9b may be employed. Other configurations and actions are the same as those of the tripod type constant velocity universal joint 1 according to the above-mentioned embodiment. Therefore, contents of the description in the embodiment are applied to omit redundant description.

The present invention is not limited to the above-mentioned embodiment. As a matter of course, the present invention may be carried out in various other embodiments without departing from the gist of the present invention. The scope of the present invention is defined in claims, and encompasses the meanings of equivalents described in claims and all changes within the scope of claims.

### DESCRIPTION OF REFERENCE SIGNS

1 tripod type constant velocity universal joint
2 outer joint member
3 tripod member
3s tripod member
3a trunnion barrel
4 roller unit
5 track groove
6 roller guide surface
7 leg shaft
7₃ leg shaft
7a outer circumferential surface
7b hollow hole
7b₁ hollow hole
7b₂ hollow hole
7b₃ hollow hole
7c bottom portion
7c3 bottom portion
11 outer ring
12 inner ring
12a inner circumferential surface
H quench-hardened layer
H′ quench-hardened layer
De effective hardened layer depth
De′ effective hardened layer depth
m gap

1-5. (canceled)

6. A tripod type constant velocity universal joint, comprising:
an outer joint member having three track grooves each having roller guide surfaces arranged opposed to each other in a circumferential direction;
a tripod member comprising three leg shafts protruding in a radial direction;
rollers inserted to the track grooves; and
inner rings, which are externally fitted to the leg shafts, and are configured to rotatably support the rollers,
the rollers each being movable along the roller guide surfaces in an axial direction of the outer joint member,
the inner rings each having an inner circumferential surface formed so as to have an arc-shaped protruding section,
the leg shafts each having an outer circumferential surface formed so as to have a straight shape in longitudinal section and a substantially elliptical shape in transverse section,
the outer circumferential surface of each of the leg shafts being held in contact with the inner circumferential surface of each of the inner rings in a direction orthogonal to an axis of the joint, and having a gap with the inner circumferential surface of the each of the inner rings in an axis direction of the joint,
wherein the each of the leg shafts has a hollow hole,
wherein the outer circumferential surface of the each of the leg shafts and a surface of the hollow hole each have a quench-hardened layer, and
wherein the quench-hardened layer is continuous in a radial direction of the each of the leg shafts from the outer circumferential surface of the each of the leg shafts to the surface of the hollow hole.

7. The tripod type constant velocity universal joint according to claim 6, wherein the quench-hardened layer is formed by carburizing, quenching, and tempering.

8. The tripod type constant velocity universal joint according to claim 6, wherein the hollow hole has an elliptical cylinder shape having a bottom portion.

9. The tripod type constant velocity universal joint according to claim 6, wherein the hollow hole has a circular cylinder shape having a bottom portion.

10. The tripod type constant velocity universal joint according to claim 6, wherein the hollow hole is formed of a forged surface.

11. The tripod type constant velocity universal joint according to claim 7, wherein the hollow hole is formed of a forged surface.
